(19) United States
(12) Patent Application Publication
(10) Pub. No.: US 2016/0241757 A1
(43) Pub. Date: Aug. 18, 2016

(54) PORTABLE MEDICAL IMAGE CAPTURING APPARATUS

(71) Applicant: MEDIMAGING INTEGRATED SOLUTION, INC., Hsinchu (TW)

(72) Inventors: CHU-MING CHENG, HSINCHU (TW); LONG-SHENG LIAO, HSINCHU (TW); MING-HSIEN HSIEH, HSINCHU (TW)

(21) Appl. No.: 15/019,434

(22) Filed: Feb. 9, 2016

(30) Foreign Application Priority Data
Feb. 13, 2015 (TW) 104105185

(51) Int. Cl. H04N 5/225

(52) U.S. Cl. CPC H04N 5/2256; H04N 5/2254; H04N 2005/2255

(57) ABSTRACT

A portable medical image capturing apparatus comprises an image sensing module, an imaging lens module and an annular illumination module. The image sensing module captures imaging light from a lesion to form an image. The imaging lens module is arranged in a hollow portion of the annular illumination module and converges the imaging light to the image sensing module. The annular illumination module includes a plurality of light emitting units arranged in an annular symmetry manner and a plurality of first and second reflectors respectively arranged on two sides of the light emitting units. At least a portion of illumination light generated by the light emitting units are reflected to the lesion by the first and second reflectors. Illumination areas generated by the light emitting units overlap to form a uniform illumination zone with high uniformity, high intensity and directionality to irradiate the lesion.

### BACKGROUND OF THE INVENTION

1. Field of the Invention

The present invention relates to a portable apparatus, particularly to a portable medical image capturing apparatus.

2. Description of the Prior Art

Some medical image capturing apparatuses are used to detect the lesion inside a body cavity, such an oral cavity or a throat, and thus need an appropriate illumination system. Non-uniform illumination may cause the lesion to reflect light speckles, degrading image quality and impairing image interpretation. Therefore, uniform illumination is basic for a medical image capturing apparatus. In recent years, more and more applications have been developed for the biological tissue fluorescent inspection technology, including fundus fluorescein angiograph, fluorescent cornea inspection, fluorescent tumor labelling (such as brain tumors, lymphatic tumors, and oral cancers), and autofluorescence imaging. Fluorescent signal is very weak. Therefore, how to prevent the illumination light from entering the imaging system and male weak fluorescent signal detectable is an important subject in the field.

In a conventional technology, the illumination system emits light to a light-guide element, and the light is internally reflected many times inside the light-guide element and then emitted from the light output face. As the light output face has been roughened, the illumination light output from the light output face is highly uniform and non-directional. Therefore, the illumination light is less likely to generate reflected stray light speckles with high intensity. However, the illuminated surface still generates omnidirectional scattered light, which would frost the entire image. Besides, the conventional illumination system suffers high light loss and poor illumination efficiency, unfavorable to provide intense illumination able to excite fluorescence from a lesion or a fluorescent agent.

Hence, a high-uniformity and high-intensity miniaturized illumination system applicable to a portable medical image capturing apparatus has been a target the manufacturers are eager to achieve currently.

### SUMMARY OF THE INVENTION

The present invention provides a portable medical image capturing apparatus, which is equipped with a plurality of light emitting units disposed annularly and symmetrically and corresponding reflection elements, wherein at least a portion of the illumination areas of the light emitting units overlap to provide a high-uniformity, high-intensity and directional illumination zone, whereby to achieve better imaging quality.

In one embodiment, the portable medical image capturing apparatus of the present invention comprises an image sensing module, an imaging lens module, and an annular illumination module. The image sensing module captures imaging light from a lesion to form an image. The imaging lens module is disposed at the light sensing side of the image sensing module to converge the imaging light to the image sensing module. The annular illumination module is disposed around the imaging lens module and comprises a plurality of light emitting units, a plurality of first reflectors and a plurality of second reflectors. The light emitting units are arranged annularly and symmetrically to generate illumination light to illuminate a lesion. The first reflectors and the second reflectors are respectively disposed at two sides of each light emitting unit. At least a portion of the illumination light generated by each light emitting unit are reflected to the lesion by at least one of the first reflectors and the second reflectors. At least a portion of the illumination areas respectively generated by the light emitting units overlap to form a uniform illumination zone for illuminating a lesion.

Below, embodiments are described in detail in cooperation with the attached drawings to make easily understood the objectives, technical contents, characteristics and accomplishments of the present invention.

### BRIEF DESCRIPTION OF THE DRAWINGS

The foregoing conceptions and their accompanying advantages of this invention will become more readily appreciated after being better understood by referring to the following detailed description, in conjunction with the accompanying drawings, wherein:

FIG. 1 is a diagram schematically showing an appearance of a portable medical image capturing apparatus according to one embodiment of the present invention;

FIG. 2 is a diagram schematically showing components of a portable medical image capturing apparatus according to one embodiment of the present invention;

FIG. 3 is a diagram schematically showing reflectors of an annular illumination module of a portable medical image capturing apparatus according to one embodiment of the present invention;

FIG. 4 is a diagram schematically showing reflectors of an annular illumination module of a portable medical image capturing apparatus according to another embodiment of the present invention;

FIG. 5 is a diagram schematically showing reflectors of an annular illumination module of a portable medical image capturing apparatus according to still another embodiment of the present invention;

FIG. 6 is a diagram schematically showing light emitting units of an annular illumination module of a portable medical image capturing apparatus according to one embodiment of the present invention; and

FIG. 7 is a diagram showing transmission wavelengths of filters of a portable medical image capturing apparatus according to one embodiment of the present invention.

### DESCRIPTION OF THE PREFERRED EMBODIMENTS

The present invention will be described in detail with embodiments and attached drawings below. However, these embodiments are only to exemplify the present invention but not to limit the scope of the present invention. In addition to the embodiments described in the specification, the present invention also applies to other embodiments. Further, any modification, variation, or substitution, which can be easily made by the persons skilled in that art according to the embodiment of the present invention, is to be also included within the scope of the present invention, which is based on the claims stated below. Although many special details are provided herein to make the readers more fully understand the present invention, the present invention can still be practiced under a condition that these special details are partially or completely omitted. Besides, the elements or steps, which are well known by the persons skilled in the art, are not described herein lest the present invention be limited unnecessarily. Similar or identical elements are denoted with similar or identical symbols in the drawings. It should be noted: the drawings are only to depict the present invention schematically but not to show the real dimensions or quantities of the present invention. Besides, matterless details are not necessarily depicted in the drawings to achieve conciseness of the drawings.

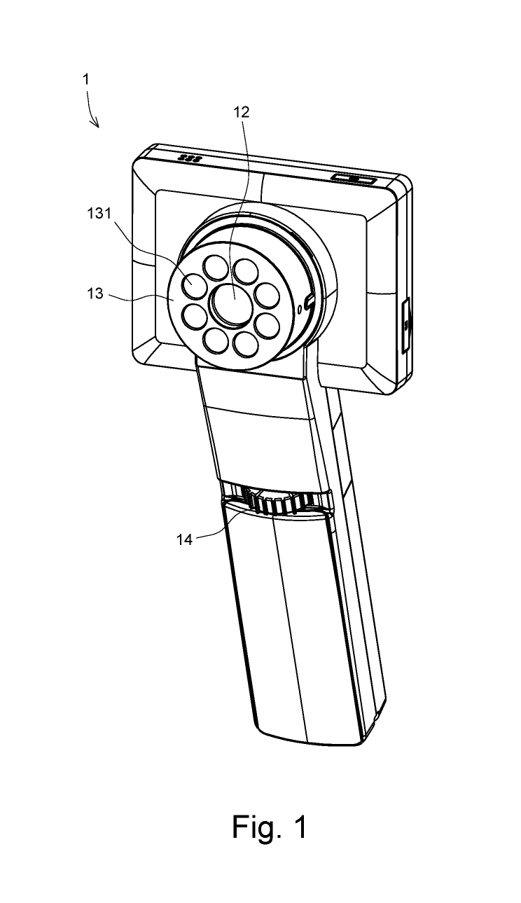

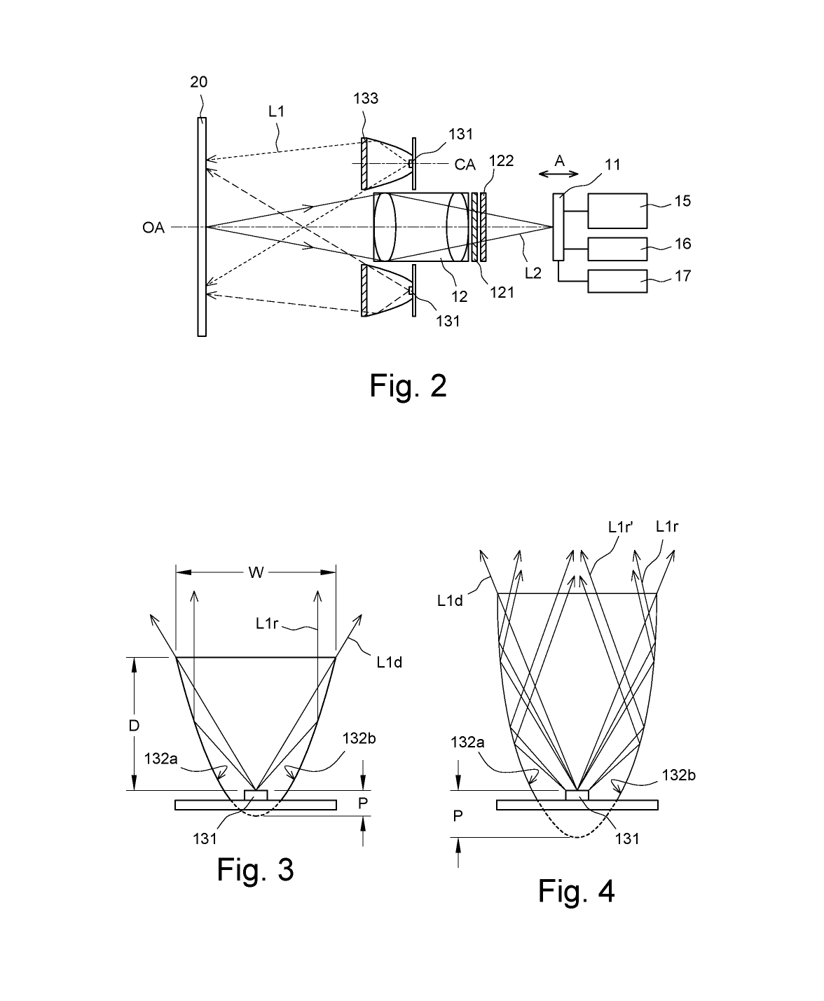

Refer to FIG. 1 and FIG. 2. In one embodiment, the portable medical image capturing apparatus 1 of the present invention comprises an image sensing module 11, an imaging lens module 12, and an annular illumination module 13. The image sensing module 11 captures imaging light L2 from a lesion 20 to form an image. For example, the image sensing module 11 may be a charge coupled device (CCD), a complementary metal oxide semiconductor (CMOS) detector, or a film. The imaging lens module 12 is disposed at the light sensing side of the image sensing module 11. The imaging lens module 12 converges imaging light that come from the lesion 20 to the image sensing module 11 to form an image. The annular illumination module 13 is disposed around the imaging lens module 12. In other words, the imaging lens module 12 is disposed at the hollow portion of the annular illumination module 13.

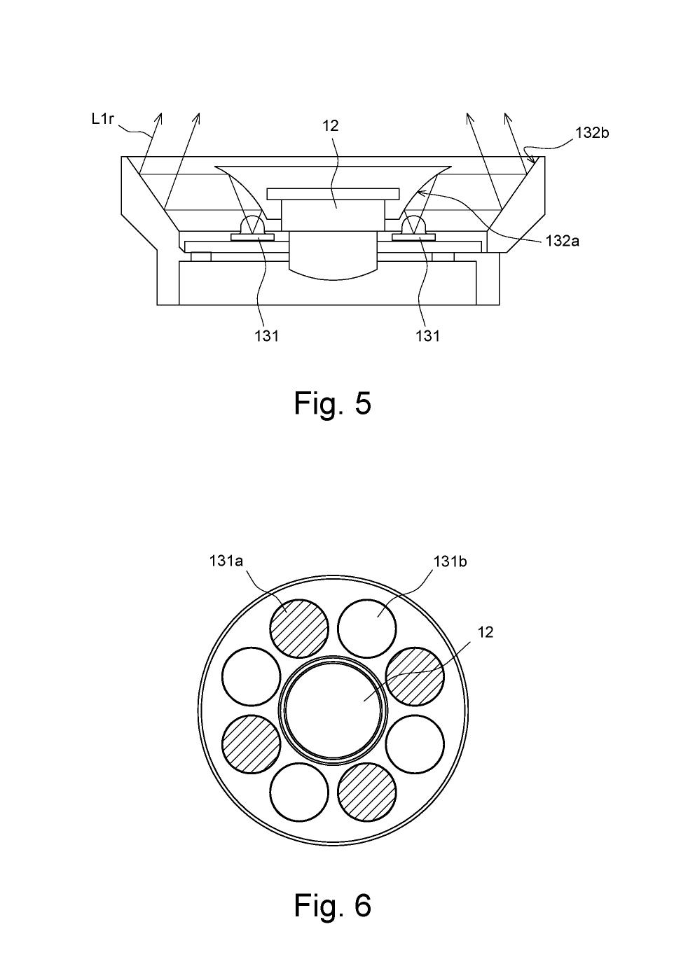

The annular illumination module 13 includes a plurality of light emitting units 131, a plurality of first reflector, and a plurality of second reflectors. The first reflectors and the second reflectors may have different designs to meet different requirements, and the details thereof will be described thereinafter. As shown in FIG. 1, the light emitting units 131 are arranged annularly and symmetrically to generate illumination light L1 for illuminating the lesion 20. Illuminated by the illumination light L1, the lesion 20 generates the imaging light L2; the imaging lens module 12 converges the imaging light L2 to the image sensing module 11 to form an image. Refer to FIGS. 3-5. In one embodiment, the first reflector 132a and the second reflector 132b are respectively disposed at two sides of each light emitting unit 131. At least a portion of the illumination light generated by each light emitting unit 131 are reflected to the lesion 20 by at least one of the first reflectors 132a and the second reflectors 132b. As shown in FIG. 3 and FIG. 4, for example, the illumination light L1d do not hit the first reflectors 132a and the second reflectors 132b; therefore, the illumination light L1d are not reflected by the first reflectors 132a and the second reflectors 132b but directly projected out; the illumination light L1r are reflected by the first reflectors 132a or the second reflectors 132b and thus converged to the central axis of the light emitting unit 131 to increase the utilization rate of the illumination light. In the embodiment shown in FIG. 5, most of the illumination light L1r are reflected by the first reflectors a132a and then reflected by the second reflectors 132b in sequence and finally reach the lesion 20.

It should be noted that at least a portion of the illumination areas generated by the light emitting units 131 overlap to form a uniform illumination zone for illuminating the lesion 20, as shown in FIG. 2. The uniform illumination zone is defined to be the illumination field whose weakest illumination point has a light intensity greater than or equal to 40% of the light intensity of the most intense illumination point. It is easy to understand: the size of a uniform illumination zone varies with the requirement of the operator or the distance between the lesion 20 and the imaging lens module 12. In one embodiment, the uniform illumination zone has a diameter of 30-80 mm.

Refer to FIGS. 1-4 again. In some embodiments, a plurality of first reflectors 132a and a plurality of second reflectors 132b corresponding to the first reflectors 132a are connected to form a plurality of annular reflectors, and a light emitting unit 131 is arranged at the central axis of each annular reflector. In one embodiment, the inner surface of the annular reflector may be a paraboloid, as shown in FIG. 3. In one embodiment, the inner surface of the annular reflector may be a compound paraboloid, as shown in FIG. 4. In the embodiment shown in FIG. 3, the light emitting unit 131 is disposed at the focus of the paraboloid, and the illumination light L1r reflected by the first reflectors 132a and the second reflectors 132b are parallel to the central axis of the light emitting unit 131; the non-reflected light L1d are directly projected to the lesion 20. Therefore, the illumination light L1d and L1r generated by the light emitting unit 131 have high directionality; the illumination light L1d and L1r generated by the light emitting unit 131 and spread within a large angle are reflected by the first reflectors 132a and the second reflectors 132b and converged to the central axis of the light emitting unit 131. Thereby is greatly increased the utilization efficiency of the illumination light.

It is easy to understand that moving the light emitting unit 131 from the focus toward the light output opening would cause a greater portion of the illumination light to be scatter without the reflection of the first reflectors 132a and the second reflectors 132b. In one embodiment, the light emitting unit 131 is disposed within a region between the focus and the apex of the paraboloid; i.e. Region P in FIG. 3, whereby the illumination light will converge to the central axis of the light emitting unit 131. Considering the fabrication difficulty and the light convergence effect of the annular reflector formed by the first reflectors 132a and the second reflectors 132b, the ratio of the inner diameter W of the light output opening and the depth D of the annular reflector may be within 0.5-1.1.

In the embodiment shown in FIG. 4, the inner surface of the annular reflector formed by the first reflectors 132a and the second reflectors 132b is a compound paraboloid. While the light emitting unit 131 is disposed at the focal plane of the compound paraboloid, the illumination light emitted from the light emitting unit 131 are reflected from different positions to form parallel illumination light L1r and L1r′ with different angles of emergence. The non-reflected illumination light L1d are directly projected to the lesion 20. As mentioned above, the position where the light emitting unit 131 is disposed influences the light convergence effect. In one embodiment, the light emitting unit 131 is disposed within a region between the focal plane and the apex of the compound paraboloid, i.e. Region P in FIG. 4. For the compound-paraboloid annular reflector formed by the first reflectors 132a and the second reflectors 132b, the ratio of the inner diameter W of the light output opening and the depth D of the annular reflector is within 0.45-0.7 in one embodiment. It is preferred for the compound-paraboloid annular reflector: the inner diameter of the light output opening is smaller than the maximum inner diameter of the inner surface. In other words, the maximum inner diameter of the compound-paraboloid annular reflector should not appear at the light output opening.

Refer to FIG. 2. In the embodiment shown in FIG. 2, the central axis CA of the annular reflector formed by the first reflectors 132a and the second reflectors 132b is parallel to the optical axis OA of the imaging lens module 12. However, the present invention does not limit that the central axis CA of the annular reflector must be parallel to the optical axis OA of the imaging lens module 12. In one embodiment, the central axis CA of the annular reflector and the optical axis OA of the imaging lens module 12 have an included angle of 0-10 degrees therebetween, whereby the illumination light slightly outside the central region can be utilized to increase the utilization rate of the illumination light.

Refer to FIG. 5. In one embodiment, a plurality of first reflectors 132a can be connected to form a first annular reflector, and a plurality of second reflectors 132b can be connected to form a second annular reflector, whereby two annular reflectors are formed coaxially. In the embodiment, the plurality of light emitting units 131 are disposed in the space between the first annular reflector formed by the first reflectors 132a and the second annular reflector formed by the second reflectors 132b. According to this structure, each of the illumination light L1r generated by the light emitting units 131 is reflected by the first annular reflector and then reflected by the second annular reflector in sequence and finally reaches the lesion. In general, the light emitting unit 131 (such as LED) normally emits divergent illumination light. In one embodiment, the reflective face of the first annular reflector formed by the first reflectors 132a may be a concave face able to converge the illumination light emitted by the light emitting units 131, such as a spherical face, an aspherical face or another conventional concave face. While the first annular reflector is disposed near the light emitting units 131, it can reflect most of the illumination light with a smaller area. In one embodiment, the curvature radius of the reflective face of the first annular reflector is 2-3 times the distance between the light emitting unit 131 and the reflective face of the first annular reflector.

In one embodiment, the first annular reflector formed by the first reflectors 132a can reflect the divergent illumination light into parallel illumination light, whereby the design of the second annular reflector formed by the second reflectors 132b can be simplified. For example, the reflective face of the second annular reflector may be a plane, and the emergence angle of the illumination light can be varied via adjusting the angle of the reflective face of the second annular reflector. However, the present invention does not limit that the reflective face of the second annular reflector must be a plane. In one embodiment, the reflective face of the second annular reflector may be a curved face able to converge the illumination light. In one embodiment, the reflective face of the first annular reflector and the optical axis OA of the imaging lens module 12 has an included angle of 45 degrees therebetween, whereby the optical path of the illumination light reflected by the first annular reflector is vertical to the optical axis OA of the imaging lens module 12. In the case that the illumination light reflected by the first annular reflector are parallel light, the distance between the first annular reflector and the second annular reflector can be arbitrarily adjusted. For example, the second annular reflector is disposed farther from the first annular reflector, whereby to form illumination light spreading in a larger angle to illuminate a lesion, and whereby to prevent the illumination light reflected by the lesion from entering the imaging lens module 12 and affecting the image quality. It should be noted that the reflective face of the first annular reflector and the optical axis OA of the imaging lens module 12 has an included angle varying between 45 and 50 degrees according to requirement.

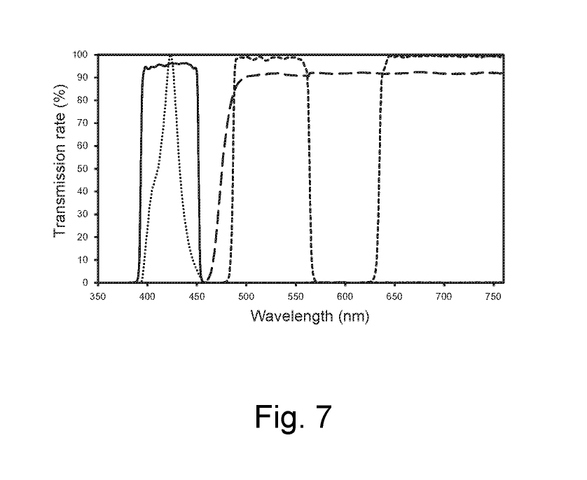

It is easy to understand that the imaging light L2 may be but is not limited to be the illumination light L1 reflected by the lesion 20. In one embodiment, the imaging light L2 may be the fluorescent light emitted by the fluorescent agent distributed in the lesion 20 and excited by the illumination light L1. In one embodiment, the imaging light L2 may be the auto-fluorescence light emitted by the lesion 20 excited by the illumination light L1. Refer to FIG. 6. In one embodiment, the plurality of light emitting units 131 include light emitting diodes 131a and 131b respectively having different central wavelengths according to requirement, such as wavelengths of visible light and short-wavelength violet light (or ultraviolet light), or wavelengths of short-wavelength violet light and ultraviolet light. For example, the portable medical image capturing apparatus is applied to fluorescent inspection, and the wavelength of the illumination light may be within 380-460 nm (shown by the dotted curve in FIG. 7), whereby the lesion or the fluorescent agent on the surface of the lesion or inside the lesion can be excited to emit fluorescent light. In one embodiment, the plurality of LEDs 131a (or 131b) having a first central wavelength and the plurality of LEDs 131b (or 131a) having a second central wavelength are arranged alternately and disposed annularly and symmetrically, whereby the operator can select illumination light having an appropriate wavelength according to requirement.

Refer to FIG. 2 again. In one embodiment, the portable medical image capturing apparatus of the present invention further comprises a band pass filter 133 disposed at the light output opening of the annular illumination module 13. The band pass filter 133 allows the illumination light having a wavelength of 380-466 nm (shown by the solid curve in FIG. 7) to pass, whereby to guarantee that the wavelengths of the illumination light output by the annular illumination module 13 fall into an appropriate range. In one embodiment, the band pass filter 133 may be formed by coating films respectively having different diffraction indexes.

In one embodiment, the portable medical image capturing apparatus of the present invention further comprises a long pass filter 121 disposed between the imaging lens module 12 and the image sensing module 11. The long pass filter 121 allows the imaging light L2 having a wavelength longer than 460 nm (shown by the long dashed curve in FIG. 7) to pass and filters out the light having wavelengths shorter than 460 nm (such as the illumination light or the environmental light) so as to improve image quality. In one embodiment, the portable medical image capturing apparatus of the present invention further comprises a notch filter 122 disposed between the long pass filter 121 and the image sensing module 11. The notch filter 122 allows imaging light L2 having wavelengths of green light (495-555 nm) and red light (650-760 nm), as shown by the short dashed curve in FIG. 7, to pass, whereby are acquired different types of images to satisfy different requirements. In one embodiment, the operator selectively moves the notch filter 122 to a position between the long pass filter 121 and the image sensing module 11. In brief, while intending to filter out the light, except the light having wavelengths of green light and red light, the operator moves the notch filter 122 to a position between the long pass filter 121 and the image sensing module 11. Otherwise, the notch filter 122 is removed.

Refer to FIG. 1 and FIG. 2. In one embodiment, the portable medical image capturing apparatus 1 of the present invention further comprises a focal length adjusting module 14 used to drive the image sensing module 11 to move linearly along the optical axis OA of the imaging lens module 12, as indicated by Arrow A in FIG. 2. In order to simplify the design, the imaging lens module 12 is kept static during adjusting the focal length.

In one embodiment, the portable medical image capturing apparatus 1 of the present invention further comprises a display module 15 electrically connected with the image sensing module 11 and displaying the images captured by the image sensing module 11. It can be understood by a person skilled in the art that the portable medical image capturing apparatus 1 of the present invention may further comprise a processing unit able to undertake computation. The processing unit may be integrated with or separated from the image sensing module 11. The processing unit can process the images captured by the image sensing module 11 and present the images on the display module 15. For example, the processing unit removes noise from the images and adjusts the contrast and brightness of the images to acquire better image quality. The technology of the processing unit is familiar to a person skilled in the art, and the details thereof will not repeat herein.

In one embodiment, the portable medical image capturing apparatus 1 of the present invention further comprises a storage unit 16 electrically connected with the image sensing module 11 and storing the images captured by the image sensing module 11. In one embodiment, the portable medical image capturing apparatus 1 of the present invention further comprises a communication interface 17 electrically connected with the image sensing module 11 and transmitting the images captured by the image sensing module 11 to an external electronic device. In one embodiment, the communication interface 17 may be a wireless communication interface, such as a WLAN (Wireless Local Area Network) interface or a Bluetooth module. In one embodiment, the communication interface 17 may be a wired connection port, such as a wired network interface, a universal serial bus (USB). In one embodiment, the communication interface 17 may be an image output interface, such as a video graphic array (VGA) port, a digital visual interface (DVI), or a high definition multimedia interface (HDMI). The image output interface enables an external display device to link to the portable medical image capturing apparatus 1 of the present invention, whereby the inspectee can watch the images of the lesion simultaneously.

In conclusion, the portable medical image capturing apparatus of the present invention has a plurality of light emitting units disposed annularly and symmetrically and a plurality of corresponding first reflectors and second reflectors, whereby at least a portion of the illumination areas of the light emitting units overlap to form an illumination zone with high uniformity, high intensity, and directionality. While the portable medical image capturing apparatus of the present invention is applied to fluorescent inspection, the uniform illumination will not impair the observation of the fluorescent signals but allows the weak fluorescent signals to be presented clearly. In addition, the illumination zone is formed by overlapping the illumination areas of a plurality of light emitting units, having a higher intensity, able to excite fluorescent light effectively (particularly autofluorescence), and favorable to imaging quality.

What is claimed is:

1. A portable medical image capturing apparatus comprising:
an image sensing module capturing imaging light from a lesion to form an image;
an imaging lens module disposed at a light sensing side of said image sensing module and converging said imaging light to said image sensing module; and
an annular illumination module surrounding said imaging lens module and further comprising:
a plurality of light emitting units disposed annularly and symmetrically, and generating illumination light to illuminate said lesion;
a plurality of first reflectors and a plurality of second reflectors respectively disposed at two sides of said light emitting units, wherein at least a portion of said illumination light generated by each said light emitting unit are reflected to said lesion by at least one of said first reflectors and said second reflectors, said light emitting units respectively generate illumination areas, and at least a portion of said illumination areas overlap to form a uniform illumination zone for illuminating said lesion.

2. The portable medical image capturing apparatus according to claim 1, wherein said first reflectors and said second reflectors corresponding to said first reflectors are connected to form a plurality of annular reflectors, and wherein each said light emitting unit is disposed at a position a central axis of one said annular reflector corresponding to said light emitting unit, and an inner surface of said annular reflector is a paraboloid or a compound paraboloid.

3. The portable medical image capturing apparatus according to claim 2, wherein said light emitting unit is disposed at a region between a focus and an apex of said paraboloid or a region between an apex and a focal plane of said compound paraboloid.

4. The portable medical image capturing apparatus according to claim 2, wherein an inner surface of said annular reflector is a compound paraboloid, and an inner diameter of a light output opening of said annular reflector is smaller than a maximum inner diameter of said inner surface.

5. The portable medical image capturing apparatus according to claim 2, wherein an inner surface of said annular reflector is a compound paraboloid, and a ratio of an inner diameter of a light output opening of said annular reflector to a depth of said annular reflector is 0.45-0.7.

6. The portable medical image capturing apparatus according to claim 2, wherein an inner surface of said annular reflector is a paraboloid, and a ratio of an inner diameter of a light output opening of said annular reflector to a depth of said annular reflector is 0.5-1.1.

7. The portable medical image capturing apparatus according to claim 1, wherein a plurality of said first reflectors are connected to form a first annular reflector, a plurality of said second reflectors are connected to form a second annular reflector, a plurality of said light emitting units are disposed between said first annular reflector and said second annular reflector, and illumination light generated by a plurality of said light emitting units are reflected by said first annular reflector, then reflected by said second annular reflector and finally reach said lesion.

8. The portable medical image capturing apparatus according to claim 7, wherein a reflective face of said first annular reflector is a concave face.

9. The portable medical image capturing apparatus according to claim 8, wherein a curvature radius of said reflective face of said first annular reflector is equal to 2-3 times a distance between said light emitting unit and said reflective face.

10. The portable medical image capturing apparatus according to claim 7, wherein a reflective face of said first annular reflector and an optical axis of said imaging lens module has an included angle of 45-50 degrees therebetween.

11. The portable medical image capturing apparatus according to claim 7, wherein a reflective face of said second annular reflector is a plane or a curved face.

12. The portable medical image capturing apparatus according to claim 1, wherein said imaging light are said illumination light reflected by said lesion, or fluorescent light emitted by said lesion excited by said illumination light, or fluorescent light emitted by a fluorescent agent distributed in said lesion and excited by said illumination light.

13. The portable medical image capturing apparatus according to claim 1, wherein said light emitting units include different types of light emitting diodes, which respectively have different central wavelengths, and wherein said light emitting diodes of an identical central wavelength are disposed annularly and symmetrically, and said light emitting diodes of different central wavelengths are arranged alternately.

14. The portable medical image capturing apparatus according to claim 1 further comprising a band pass filter disposed at an light output opening of said annular illumination module and allowing said illumination light having wavelengths of 380-460 nm to pass.

15. The portable medical image capturing apparatus according to claim 1 further comprising a long pass filter disposed between said imaging lens module and said image sensing module and allowing said imaging light having wavelengths longer than 460 nm to pass.

16. The portable medical image capturing apparatus according to claim 15 further comprising a notch filter selectively disposed between said long pass filter and said image sensing module and allowing said imaging light beams having wavelengths of green light and red light to pass.

17. The portable medical image capturing apparatus according to claim 1 further comprising a focal length adjusting module driving said image sensing module to move linearly along an optical axis of said imaging lens module, wherein said imaging lens module is kept static.

18. The portable medical image capturing apparatus according to claim 1 further comprising a display module electrically connected with said image sensing module and presenting images captured by said image sensing module.

19. The portable medical image capturing apparatus according to claim 1 further comprising a storage module electrically connected with said image sensing module and storing images captured by said image sensing module.

20. The portable medical image capturing apparatus according to claim 1 further comprising a communication interface electrically connected with said image sensing module and transmitting images captured by said image sensing module to an external electronic device.
